(19) United States
(12) Patent Application Publication
(10) Pub. No.: US 2018/0105161 A1
(43) Pub. Date: Apr. 19, 2018

(54) CONTROL METHOD OF DRIVING MODE OF HYBRID VEHICLE AND CONTROL SYSTEM FOR THE SAME

(71) Applicants: HYUNDAI MOTOR COMPANY, Seoul (KR); KIA MOTORS CORPORATION, Seoul (KR)

(72) Inventors: Jee Wook HUH, Bucheon-si (KR); Chun Hyuk LEE, Suwon-si (KR); Dong Jun SHIN, Hwaseong-si (KR)

(21) Appl. No.: 15/715,013

(22) Filed: Sep. 25, 2017

(30) Foreign Application Priority Data
Oct. 13, 2016 (KR) 10-2016-0132586

(51) Int. Cl. B60W 20/15; B60W 20/20; B60W 30/194

(52) U.S. Cl. CPC B60W 20/15; B60W 2510/0676; B60W 30/194; B60W 20/20

(57) ABSTRACT

A control method of a driving mode of a hybrid vehicle and a control system for the method, the method including a coolant temperature-checking step of checking a coolant temperature by means of a controller, a first mode-performing step of increasing the coolant temperature by always operating an engine by means of the controller and of driving the vehicle in an HEV mode, a second mode-performing step of operating the engine by means of the controller and of driving the vehicle in the HEV mode, and a normal mode-performing step of driving the vehicle in the HEV mode by means of the controller.

### CROSS REFERENCE TO RELATED APPLICATION

The present application claims priority to Korean Patent Application No. 10-2016-0132586, filed Oct. 13, 2016, the entire contents of which is incorporated herein for all purposes by this reference.

### BACKGROUND OF THE INVENTION

### Field of the Invention

The present invention relates to a control method of a driving mode of a hybrid vehicle and a control system for the same and, more particularly to a method of controlling a driving mode for performing a heating mode in cold operation and a system for controlling the driving mode.

### Description of the Related Art

A hybrid vehicle is equipped with an engine and a driving motor that provide power for driving the vehicle. Heating of a vehicle is required in cold operation and it may be expressed as a situation in which the vehicle requires a heating mode.

Thermal energy for heating a hybrid vehicle can be obtained in various ways and one way is to obtain thermal energy from an engine. However, whether an engine is operated and appropriate selection of the way of generating power for driving a vehicle from the relationships between a driving motor and the engine are important matters to select in terms of efficiency of a vehicle.

The foregoing is intended merely to aid in the understanding of the background of the present invention, and is not intended to mean that the present invention falls within the purview of the related art that is already known to those skilled in the art.

### SUMMARY OF THE INVENTION

An object of the present invention is to improve operation efficiency of a vehicle and achieve effective heating by efficiently controlling an engine and determining a driving mode in cold operation.

A method of controlling a driving mode of a hybrid vehicle according to the present invention includes a coolant temperature-checking step of checking a coolant temperature by means of a controller when a heating mode of the hybrid vehicle is turned on; a first mode-performing step of increasing the coolant temperature by always operating an engine by means of the controller when the coolant temperature is less than a first temperature and of driving the vehicle in an HEV mode when a vehicle speed is a first vehicle speed or more; a second mode-performing step of operating the engine by means of the controller only when the vehicle is driven and when the coolant temperature is the first temperature or more and less than the second temperature, and of driving the vehicle in the HEV mode when the vehicle speed is the first vehicle speed or more; and a normal mode-performing step of driving the vehicle in the HEV mode when the coolant temperature is equal to or higher than a critical temperature that is set higher than the second temperature and the vehicle speed is equal to or higher than a critical vehicle speed that is set higher than the first vehicle speed by means of the controller.

In the second mode-performing step, when the vehicle speed is less than the first vehicle speed, the controller may drive the vehicle in a series mode in which a battery is charged with power from the engine and the vehicle is driven by power from the driving motor.

A driving determination vehicle speed for determining whether the vehicle is driven may be set in advance in the controller, and in the second mode-performing step, when the vehicle speed is the driving determination vehicle speed or more, the controller may determine that the vehicle is driven and operates the engine.

The method may further include a third mode-performing step in which when the coolant temperature is a third temperature that is the second temperature or more and less than the critical temperature and the vehicle speed is lower than the first vehicle speed by a predetermined level, the controller operates the engine so that engine RPM and driving motor RPM can be synchronized at the first vehicle speed, and drives the vehicle in the HEV mode at the first vehicle speed.

In the second mode-performing step, the controller may determine that the vehicle is driven when the vehicle speed is equal to or higher than the driving determination vehicle speed that is set in advance in the controller, and the vehicle speed lower than the first vehicle speed by the reference value may be higher than the driving determination vehicle speed.

The method may further include a fourth mode-performing step in which the controller drives the vehicle in the HEV mode when the coolant temperature is the third temperature or more and less than the critical temperature and the vehicle speed is a second vehicle speed that is higher than the first vehicle speed and lower than the critical vehicle speed.

In the fourth mode-performing step, when the vehicle speed is lower than the second vehicle speed by the reference value, the controller may operate the engine so that the engine RPM and the driving motor RPM can be synchronized.

The vehicle speed that is lower than the second vehicle speed by the reference value may be higher than the first vehicle speed.

A system for controlling a driving mode of a hybrid vehicle according to the present invention includes: a temperature sensor for measuring coolant temperature; an engine for providing power for driving the vehicle or power for charging a battery by rotating a generator; a driving motor for providing power for driving the vehicle using electricity of the battery; and a controller checking coolant temperature when a heating mode of the hybrid vehicle is turned on, increasing coolant temperature by always operating the engine when the coolant temperature is less than a first temperature and driving the vehicle in an HEV mode when a vehicle speed is a first vehicle speed or more; operating the engine only when the vehicle is driven and driving the vehicle in the HEV mode when the vehicle speed is the first vehicle speed or more, when the coolant temperature is the first temperature or more and less than a second temperature, operating the engine so that engine RPM and driving motor RPM can be synchronized at the first vehicle speed and driving the vehicle in the HEV mode at the first vehicle speed when the coolant temperature is the second temperature or more and less than a third temperature and the vehicle speed is lower than the first vehicle speed by a reference value, driving the vehicle in the HEV mode when the coolant temperature is the third temperature or more and less than a critical temperature and the vehicle speed is equal to or higher than a second vehicle speed that is higher than the first vehicle speed and lower than a critical vehicle speed, and driving the vehicle in the HEV mode when the coolant temperature is the critical temperature or more and the vehicle speed is equal to or higher than the critical vehicle speed that is set higher than the first vehicle speed.

According to the method and system for controlling a driving mode of a hybrid vehicle, it is possible to improve driving efficiency of a vehicle and perform effective heating by efficiently controlling the operation of an engine and determining a driving mode in cold operation of the vehicle.

In particular, since whether to operate the engine and a driving mode of a vehicle are determined, depending on the required degree of heating, on the basis of the coolant temperature, it is possible to effectively improve fuel efficiency in a heating mode during cold operation.

Further, since the engine is operated only when the vehicle is driven and the vehicle is driven in the HEV mode only when the vehicle speed is the first vehicle speed or more in the second mode, it is possible to effectively improve fuel efficiency in a heating mode.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows a flowchart illustrating a method of controlling a driving mode of a hybrid vehicle according to an embodiment of the present invention;

FIG. 2 shows a diagram showing divided coolant temperatures for determining of a driving mode of a vehicle in a method and system for controlling a driving mode of a hybrid vehicle according to the present invention;

FIG. 3 shows a diagram showing a change in engine RPM in each driving mode in the method and system for controlling a driving mode of a hybrid vehicle according to the present invention; and

FIG. 4 shows a diagram schematically showing a system for controlling a driving mode of a hybrid vehicle according to an embodiment of the present invention.

### DETAILED DESCRIPTION OF THE INVENTION

Hereinafter, exemplary embodiments of the present invention will be described in detail with reference to the accompanying drawings.

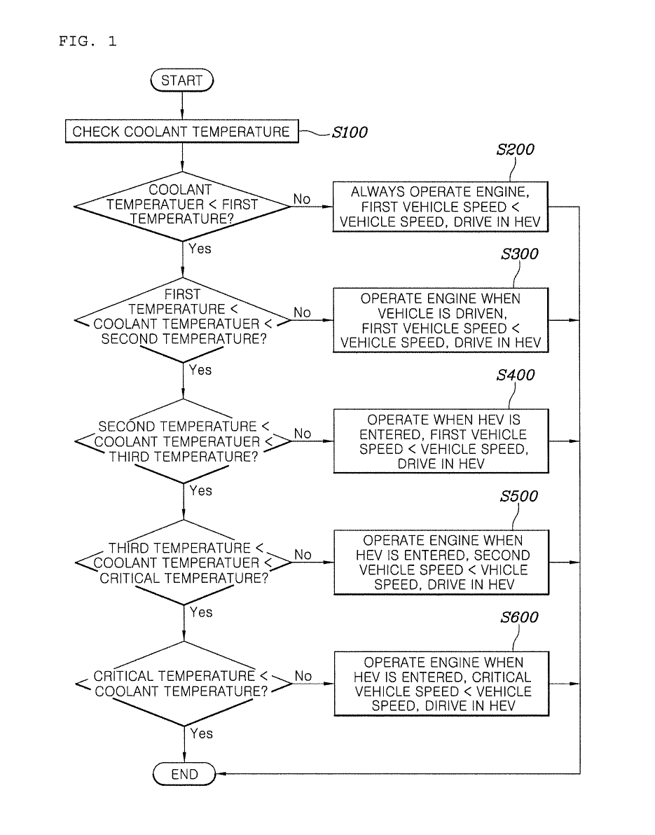

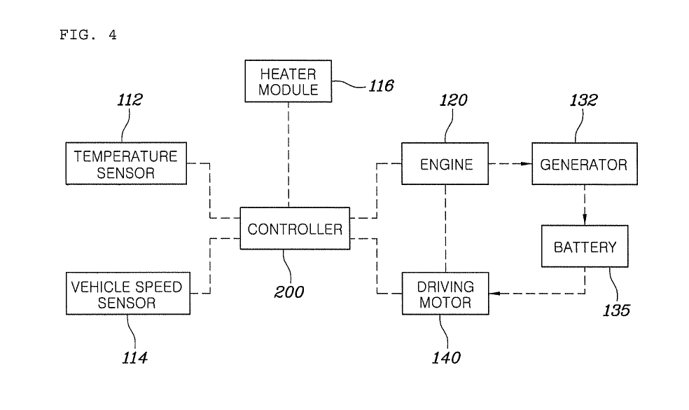

A method of controlling a driving mode of a hybrid vehicle according to the present invention, as shown in FIGS. 1 to 4, includes a coolant temperature-checking step of checking a coolant temperature by means of a controller that may be an electronic circuitry or a component including at least one processor to carry out the aforementioned functional step, when a heating mode of the hybrid vehicle is turned on (S100); a first mode-performing step of increasing the coolant temperature by always operating an engine 120 (FIG. 4) by means of the controller 200 (FIG. 4) when the coolant temperature is less than a first temperature and of driving the vehicle in an HEV mode when a vehicle speed is a first vehicle speed or more (S200); a second mode-performing step of operating the engine 120 by means of the controller 200 only when the vehicle is driven and when the coolant temperature is the first temperature or more and less than the second temperature and of driving the vehicle in the HEV mode when the vehicle speed is the first vehicle speed or more (S300); and a normal mode-performing step of driving the vehicle in the HEV mode when the coolant temperature is equal to or higher than a critical temperature that is set higher than the second temperature and the vehicle speed is equal to or higher than a critical vehicle speed that is set higher than the first vehicle speed by means of the controller 200 (S600).

In detail, in the coolant temperature-checking step (S100), when a heating mode of the hybrid vehicle is turned on, the controller 200 checks the coolant temperature.

In the present invention, the controller 200 can control the engine 120 that provides power for driving the vehicle and is preferably connected with a driving motor 140 to transmit/receive signals. More preferably, the controller 200 may be an ECU that is in charge of control of the engine 120 or an HCU that is in charge of control of both the engine 120 and the driving motor 140.

A situation in which heating of a vehicle is required is defined as a situation in which a heating mode of a vehicle has been set to be on in the present invention. That is, a heating mode of a vehicle is a situation in which it is required to increase the temperature of the interior of the vehicle or the temperature of an engine room, which is usually required in cold driving.

Meanwhile, the heating mode of a vehicle may be manually turned on by a passenger or may be automatically turned on by the controller 200 on the basis of the coolant temperature.

The coolant temperature is a factor showing a temperature condition that is a driving condition of a vehicle. That is, the coolant temperature is an index showing whether a vehicle is in a cold situation, that is, what level the temperature condition is at in a cold situation.

Although the temperature condition may be used instead of the coolant temperature in the present invention, if a vehicle is started again within a predetermined time after the heating mode is performed, the level of heating for the vehicle may be lower under the same temperature condition, so the actual influence on the vehicle from the atmospheric temperature and a coolant temperature more efficiently showing the current status of the vehicle can be used in the present invention.

The controller 200 determines the level of cold operation by checking the coolant temperature when the heating mode of a vehicle is turned on, that is, if heating of a vehicle is required. In this case, the coolant temperature can be checked in various ways, for example using a water temperature sensor 112 or obtaining and substituting an oil temperature into a specific conversion equation.

In the first mode-performing step (S200), the controller 200 increases the coolant temperature by always operating the engine 120 when the coolant temperature is less than the first temperature, and drives the vehicle in the HEV mode when the vehicle speed is the first vehicle speed or more.

A plurality of vehicle control modes in which determination conditions of driving modes are set in advance in consideration of the heating level of the vehicle and the fuel efficiency in accordance with the level of the coolant temperature with the heating mode of the vehicle turned on are set in the controller 200.

The control modes of a vehicle include a first mode, a second mode, and a normal mode, conditions for operating or not the engine 120 and determining the driving modes such as an EV mode and an HEV mode of the vehicle are set in the control modes, and the driving modes of the vehicle are determined in accordance with the conditions.

The controller 200 performs the first mode as a control mode of the vehicle when determining that the coolant temperature is less than the first temperature. The first temperature corresponds to a condition for performing the first mode when the heating level required for the vehicle is the highest in the vehicle control modes set in the controller 200 and is set lower than a coolant temperature that corresponds to a condition for entering the second mode or the normal mode. The first temperature can be set on the basis of experimental results and may be set as various values in terms of other control strategies.

When the vehicle is in the heating mode and the coolant temperature is the first temperature of less, the controller 200 determines whether to operate the engine 120 and a driving mode by performing the first mode, in which the engine 120 is always operated regardless of whether the vehicle stops.

The thermal energy for heating is usually obtained from the engine 120 in the heating mode of a vehicle. The first mode is a control mode in which the heating level is set highest in the vehicle control modes set in the controller 200, so the heating amount of a vehicle is set highest by always operating the engine 120.

The heating amount of a vehicle can be set to correspond particularly to an increase of the coolant temperature. That is, the fact that the heating amount is set highest means that the coolant temperature most rapidly increases, in which the actual heating level using a heater module 116 in a vehicle may be separately controlled.

However, the heating level of a vehicle is set highest in the first mode, so the air that can be provided by the heater module 116 in the vehicle can be most rapidly increased to the highest temperature in comparison to other control modes.

Further, a temperature increase of other devices to be heated, other than the heater module 116 in the vehicle, may be influenced, if necessary, by increasing the heating level of the vehicle.

The driving mode of the vehicle is set as the HEV mode when the vehicle speed is the first vehicle speed or more in the first mode. In the present invention, a vehicle speed sensor 114 for measuring the vehicle speed may be separately provided and the controller 200 may be provided with vehicle speed information through GPS information.

In the present invention, the EV mode and the HEV mode of the driving modes of a vehicle is discriminated in accordance with whether power from the engine 120 is used to drive the vehicle rather than whether the engine 120 is operated.

That is, the EV mode is a mode in which a vehicle is driven by the power from the driving motor 140 rather than the power from the engine 120 regardless of whether the engine 120 is operated. The HEV mode means a mode in which the engine 120 is operated and the power from both of the engine 120 and the driving motor 140 is used to drive a vehicle.

The engine 120 is always operated regardless of whether a vehicle is stopped in the first mode, and the power from the engine 120 is not used to drive the vehicle and the vehicle is driven by the power from the driving motor 140 in the EV mode when the vehicle speed is the first speed or less.

Meanwhile, in the present invention a series mode in which the engine 120 is operated in the EV mode and the power from the engine 120 is used to charge a battery 135 for operating the driving motor 140.

Accordingly, the first mode of the present invention corresponds to the case in which the engine 120 is always operated, but a driving mode of a vehicle may be determined as the EV mode in which the vehicle is driven by the power from the driving motor 140 rather than the power from the engine 120, and if necessary, a series mode in which the battery 135 is charged by the power from the engine 120 may be implemented as the EV mode. Whether to implement the series mode may be determined on the basis of the remaining electricity of the battery 135 or in consideration of other control strategies.

However, the power from the engine 120 is not used to drive a vehicle even though the engine 120 is operated in the first mode, so the fuel efficiency is not as high compared with other control modes.

Accordingly, the condition for changing into the HEV mode is relaxed as compared with the normal mode so that the power from the engine 120 can be used to drive a vehicle in the first mode.

A line in a graph in which the EV mode and the HEV mode are converted for various factors as conditions for changing from the EV mode into the HEV mode is defined as an EV line in the present invention.

That is, the condition for changing from the EV mode into the HEV mode may include various variables other than the vehicle speed, but in the present invention, the condition for changing particularly from the EV mode into the HEV mode is set for the vehicle speed (that is, the EV line for the vehicle speed is adjusted in each control mode).

As described above, the normal mode in which a vehicle is normally driven without a specific heating mode in accordance with a cold operation, as will be described below, is included in the control modes of a vehicle in the present invention, other than the first mode in which the heating level is set highest.

The first mode is an HEV mode entry condition in which the first vehicle speed is set and the first vehicle speed is lower than a critical vehicle speed that is an HEV mode entry condition in the normal mode. That is, the driving mode of a vehicle more quickly enters the HEV mode than a normal situation (normal mode) on the basis of the vehicle speed in the first mode to prevent reduction of fuel efficiency.

The first mode is disadvantageous in terms of fuel efficiency because the engine 120 is operated regardless of whether the vehicle is stopped in the first mode, so the HEV mode is quickly entered so that the power from the engine 120 can be used to drive the vehicle, which is advantageous in terms of fuel efficiency.

The first vehicle speed can be determined in various ways. However, whether the rotational speeds of the engine 120 and the driving motor 140 can be synchronized should be considered.

In the HEV mode in the present invention, the engine 120 and the driving motor 140 are interlocked with the rotational speeds (RPM) synchronized. The state in which the engine 120 and the driving motor 140 are interlocked through a clutch etc. is defined as a lock-up state in the present invention.

A minimum RPM may be required to keep the engine 120 operating not stopped in the lock-up state, but when the RPM of the driving motor does not satisfy the minimum RPM of the engine, the HEV mode may not be entered.

Accordingly, in the first mode of the present invention, the first vehicle speed is set by relaxing the HEV entry mode to improve fuel efficiency, but it should be determined to be able to satisfy the RPM at which the engine 120 can be operated at least in the lock-up state.

The first vehicle speed of the present invention can be determined in consideration of various control strategies for a vehicle in addition to the restriction described above. Determining the first vehicle may have the same meaning as determining the RPMs of the engine 120 and the driving motor when lock-up is made. As described above, the first vehicle speed is set lower than the critical vehicle speed corresponding to the HEV mode entry condition in the normal mode.

The controller 200 can perform lock-up preparation control that reduces the engine RPM at a vehicle speed lower than the first vehicle speed. The engine 120 operated in the EV mode may idle, and the HEV mode may be entered at RPM lower than idle RPM of the engine 120 in the first mode to enter the HEV mode as quickly as possible.

In this case, it may be required to reduce the engine RPM or the engine torque to a predetermined level in order to smoothly synchronize the engine 120 and the driving motor 140, so the controller 200 performs this process through the lock-up preparation control.

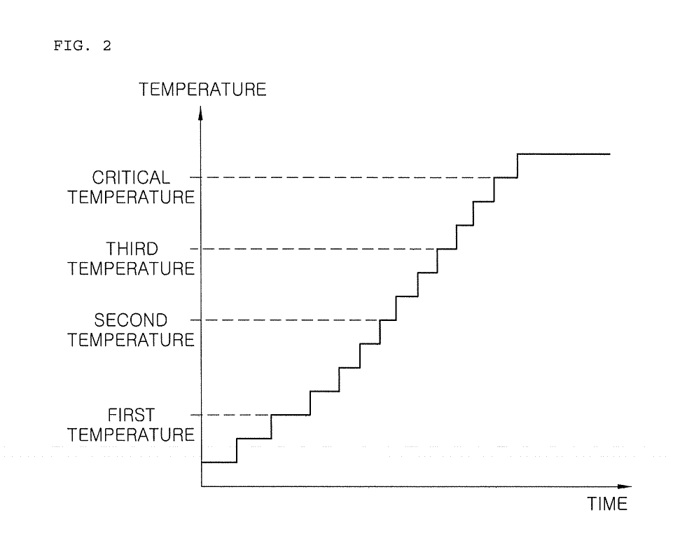

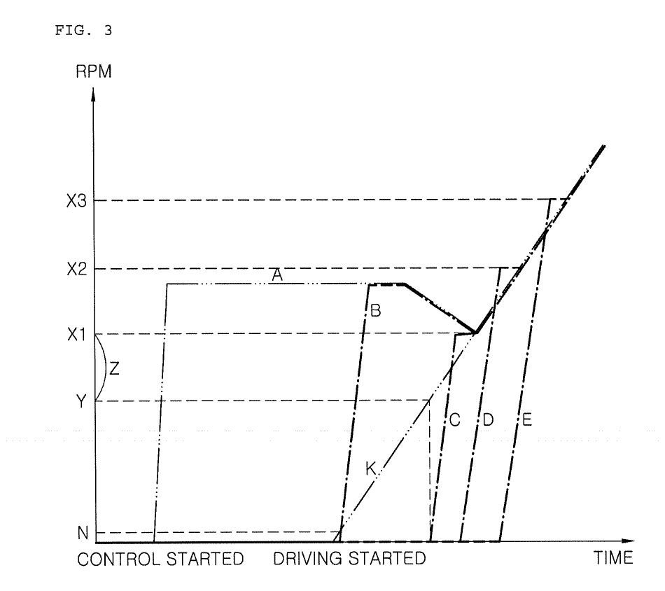

The characteristics of the first mode are described with reference to FIGS. 2 and 3.

First, when the coolant temperature of a vehicle is the first temperature in FIG. 2, the controller 200 performs the first mode as the control mode of the vehicle. The operation status of the engine 120 with the first mode performed is shown by a line A.

When control is started, the engine 120 is started even if the vehicle is stopped. It can be seen from the line A that RPM is maintained at a predetermined level even though the vehicle speed is 0, in which the RPM of the engine may be determined in various ways. This is referred to as idle RPM of the engine 120 hereafter for the convenience of description.

According to the line A in FIG. 3, the vehicle speed is 0 and the idle RPM is maintained. A line K shows the driving motor RPM and the values shown by the line K may be construed as being values corresponding to the driving motor RPM and the vehicle speed.

It can be seen that the line K increases from the point of ‘driving started’ and the controller 200 performs the lock-up preparation control to reduce the engine RPM before the line K reaches X1 that is the driving motor RPM corresponding to the first vehicle speed.

This is a result of relaxing the HEV mode entry condition in various embodiments of the present invention and an embodiment in which the RPMs of the engine 120 and the driving motor 140 that can be locked up are lower than the idle RPM is shown in FIG. 3.

The engine 120 is controlled to have RPM lower than the idle RPM to prepare lock-up, and accordingly, it can be seen that the RPMs of the engine 120 and the driving motor 140 are synchronized at X1 that is the engine RPM corresponding to the first vehicle speed.

That is, the engine 120 and the driving motor 140 are synchronized by locking up at X1 in FIG. 3, which means that the driving mode of a vehicle has entered the HEV mode in the present invention.

Meanwhile, in the second mode-preparing step (S300), when the coolant temperature is first temperature or more and less than the second temperature, the controller 200 operates the engine only when the vehicle is driven, and drives the vehicle in the HEV mode when the vehicle speed is the first vehicle speed or more.

When the coolant temperature is the first temperature or more and less than the second temperature, which is the first mode entry condition, the controller 200 performs the second mode as the control mode of the vehicle, in which the second temperature is set higher than the first temperature and is equal to or less than a critical temperature that is a normal mode entry condition. However, the second temperature may be various values in consideration of the control strategy.

In the second mode, the heating level for a vehicle is set lower than that in the first mode and higher than that in the normal mode.

The controller 200 operates the engine 120 to increase the coolant temperature, but operates the engine 120 only when it is determined that the vehicle is driven, unlike the first mode. That is, when the vehicle is stopped, the engine 120 is stopped to increase the fuel efficiency, as compared with the first mode.

Further, in the second mode, the controller 200 converts the driving mode of a vehicle from the EV mode into the HEV mode when the first vehicle speed is reached, as in the first mode. That is, in the second mode, as in the first mode, the power from the engine 120 is used to drive the vehicle by converting the driving mode into the HEV mode at a vehicle speed lower than that in the normal mode to increase the fuel efficiency.

Referring to FIG. 2, the second temperature higher than the first temperature is shown. When the heating mode is turned on and the coolant temperature is the first temperature or more and less than the second temperature, the RPM of the engine 120 is controlled to follow the line B in FIG. 3.

That is, the line B in FIG. 3 shows the engine RPM with the second mode performed. It can be seen that the line B corresponds to 0 before the line K corresponding to the driving motor RPM and the vehicle speed increases, which means that the engine 120 is maintained in the stopped state with the vehicle stopped.

Then, it can be seen that the engine RPM increases and the engine 120 is operated at the ‘driving start’ where the line K increases and the embodiment shown in FIG. 3 corresponds to a case in which the engine RPM is lower than the idle RPM at the first vehicle speed that is an HEV mode entry condition in the first mode and the second mode, as described in relation to the first mode. Accordingly, it can be seen that the lock-up preparation control is performed from the line B for the second mode, as the line A for the first mode.

The lock-up preparation control may be performed or not, depending on the engine RPM corresponding to the first vehicle speed, as described above. The vehicle in the second mode enters the HEV mode from X1 where lock-up has been made.

Meanwhile, in the normal mode-performing step (S600), when the coolant temperature is equal to or less than a critical temperature that is set higher than the second temperature and the vehicle speed is equal to or higher than a critical vehicle speed that is set higher than the first vehicle speed, the controller 200 drives the vehicle in the HEV mode.

The normal mode of the control modes of a vehicle in which an operation condition of the engine 120 and a driving mode condition of the vehicle are set provides the smallest heating amount for the vehicle and corresponds to a control mode with the highest fuel efficiency, in comparison to other control modes.

When the coolant temperature becomes the critical temperature or more, the controller 200 performs the normal mode. When the normal mode is performed, the engine 120 is not operated unless the HEV mode entry is required. That is, the engine 120 is not operated even though the vehicle is being driven, unlike the second mode.

Meanwhile, when the vehicle corresponds to the critical speed, the controller 200 drives the vehicle into the HEV mode, and synchronizes the engine 120 with the driving motor 140 by operating the engine 120 when HEV mode entry is required. The critical vehicle speed is higher than the first vehicle speeds in the first mode and the second mode.

The operation time of the engine is relatively long in the first mode and the second mode, so it is advantageous in terms of fuel efficiency to quickly enter the HEV mode. However, in the normal mode, since the engine 120 is not operated unless HEV mode entry is required, it is most advantageous in terms of fuel efficiency, thus the engine 120 that is operated when the HEV mode is entered is also controlled at the optimal operation point, so the normal mode is a control mode with maximum fuel efficiency.

The optimal fuel efficiency of the engine 120 may depend on the relationship between the engine torque and the engine RPM and the engine RPM corresponding to the first vehicle speed is relatively low to achieve the optimal fuel efficiency.

That is, the first speed is set to prevent waste of the power from the engine 120 by advancing the entry point of time of the HEV mode and the critical vehicle speed may be determined as a level where the optimal fuel efficiency of the engine 120 can be achieved in consideration of the operation point of the engine 120.

The critical vehicle speed may be determined in various ways in consideration of the control strategy in addition to the operation point of the engine 120, as described above, and is higher at least than the first vehicle speed.

Referring to FIG. 2, a critical temperature higher than the first temperature and the second temperature is shown. When the coolant temperature is the critical temperature or more, the controller 200 controls the engine 120 to follow the line E in FIG. 3. That is, the line E in FIG. 3 shows the engine RPM in the normal mode.

Referring to the line E in FIG. 3, the engine 120 has been stopped and is then locked up with the driving motor 140 when the driving motor RPM reaches X3, thereby implementing the HEV mode. That is, the point of time to enter the HEV mode from the normal mode means the point of time where the driving motor RPM meaning the current vehicle speed corresponds to X3 corresponding to the RPM at the critical vehicle speed.

Meanwhile, it can be seen from FIG.3 that the engine 120 in the normal mode is operated at a vehicle speed lower than the critical vehicle speed by a predetermined level, which can be understood as being for the lock-up preparation control described above.

In the embodiments, the RPM at the point of time of lock-up is lower than the RPM of the engine that is idling in the first mode and the second mode, the control of reducing the engine RPM before the lock-up is performed.

However, the line E in FIG. 3 which is provided as an embodiment of the normal mode shows that the engine RPM 120 is operated at the RPM for lock-up from the stopped state, so there is a need for increasing the engine RPM before the lock-up. Accordingly, the engine 120 is operated at a vehicle speed lower than the critical vehicle speed by a predetermined level and the engine RPM is controlled to reach X3 in FIG. 3 by the lock-up preparation control.

However, as described above, the lock-up preparation control by the controller 200 may be performed or not, if necessary, as described above (for example, when the engine RPM before lock-up is the same as a target RPM for lock-up). The case in which the engine 120 is not operated before the lock-up is entered is described in detail hereafter.

As a result, when the normal mode is performed in the present invention, the heating amount of a vehicle is minimized, but the fuel efficiency is maximized, as compared with other control modes. That is, according to the present invention, it is possible to efficiently control the driving modes of a vehicle by performing the control modes so that the heating amount and the fuel efficiency of the vehicle are optimized in accordance with the currently required heating level in consideration of the heating level required for the vehicle based on the coolant temperature.

Meanwhile, as in FIGS. 1 and 4, in the method of controlling a driving mode of a hybrid vehicle according to an embodiment of the present invention, in the second mode-performing step (S300), when the vehicle speed is less than the first vehicle speed, the controller 200 drives the vehicle in the series mode in which the battery 135 is charged with the power from the engine 120 and the vehicle is driven by the power from the driving motor 140.

In detail, in the second mode, the controller 200 determines the driving mode of a vehicle as the HEV mode or the EV mode on the basis of the first vehicle speed. According to an embodiment of the present invention, when the vehicle is driven in the EV mode at a vehicle speed lower than the first vehicle speed, the controller 200 implements the series mode during the EV mode.

The second mode is set such that the engine 120 is operated only when it is determined that the vehicle is being driven, and when the engine 120 is operated, the series mode in which the battery 135 is charged with the power from the engine 120 and the vehicle is driven by the power from the driving motor 140.

When the series mode is implemented, the battery 135 is charged and the vehicle is driven by the power from the driving motor 130, so the possibility of discharging of the battery 135 is remarkably reduced. Further, since the power from the engine 120 is used to charge the battery 135, the fuel efficiency can also be improved in comparison to the first mode.

Meanwhile, as shown in FIGS. 1, 3, and 4, in the method of controlling a driving mode of a hybrid vehicle according to an embodiment of the present invention, a driving determination vehicle speed is set in advance to determine whether a vehicle is driven in the controller 200, and in the second mode-performing step (S300), when the vehicle speed is the driving determination vehicle speed or more, the controller 200 determines that the vehicle is driven and operates the engine 120.

In the second mode, the controller 200 operates the engine 120 only when the vehicle is driven to improve the fuel efficiency in comparison to the first mode. However, the driving determination vehicle speed is set in the controller 200 to determine whether the vehicle is efficiently driven in an embodiment of the present invention.

The driving determination vehicle speed is a reference for checking whether the vehicle is stopped or driven and it would be technically a low speed. Preferably, the driving determination vehicle speed may be determined within 0-10 km/h.

The vehicle speed may be generated even if a driver does not intend and it is not a meaningful driving state in which the engine 120 should be operated, so according to an embodiment of the present invention, a meaningful driving state of a vehicle is determined on the basis of the driving determination vehicle speed so that the vehicle can be effectively controlled.

N that corresponds to driving motor RPM corresponding to the driving determination vehicle speed is shown in FIG. 3. That is, even if a vehicle speed is generated due to various reasons even if a driver does not intend, when the vehicle speed is the driving determination vehicle speed or more and the RPM of the driving motor 140 is N or less, the controller 200 determines that the vehicle is stopped.

Meanwhile, as shown in FIGS. 1 to 4, the method of controlling a driving mode of a hybrid vehicle according to an embodiment of the present invention further includes a third mode-performing step (S400) in which when the coolant temperature is a third temperature that is the second temperature or more and less than the critical temperature and the vehicle speed is lower than the first vehicle speed by a predetermined level, the controller 200 operates the engine 120 so that the engine RPM and the driving motor RPM can be synchronized at the first vehicle speed, and drives the vehicle in the HEV mode at the first vehicle speed.

In detail, the first mode, the second mode, and the third mode are set as the control mode of a vehicle in the controller 200. A third temperature is set in advance in the controller 200 to enter the third mode and when the coolant temperature is the second temperature or more and less than the third temperature, the controller 200 performs the third mode.

The third temperature is preferably higher than the second temperature, but is set smaller than the critical temperature for the normal mode. That is, the third mode is a control mode that is applied when the heating level for a vehicle is lower than those in the first mode and the second mode, and in the third mode, the heating amount in the vehicle is smaller than that in the second mode, but the fuel efficiency is improved in comparison to the second mode.

When the coolant temperature is the second temperature or more and less than the third temperature, the engine RPM is controlled to follow the line C in FIG. 3. Referring to the line C, it can be seen that the engine 120 is not operated before the vehicle speed corresponds to the first vehicle speed and the HEV mode entry is not required.

That is, it can be seen that the operation time of the engine 120 is reduced in the third mode in comparison to the second mode, so consumption of the power from the engine is reduced and the fuel efficiency is improved.

Meanwhile, as described above in relation to the normal mode, the engine RPM is increased by operating the engine 120 before the first vehicle speed for entering the HEV mode is reached in the third mode. To this end, according to an embodiment of the present invention, the engine 120 is operated at a vehicle speed that is lower than the first vehicle speed by a reference level.

Referring to FIG. 3, the RPM of the engine 120 or the driving motor 140 at the first vehicle speed is X1 and the RPM of the engine 120 or the driving motor 140 at a vehicle speed that is lower than the first vehicle speed by the reference level is Y.

That is, when the reference value is converted into the RPM of the engine 120 or the driving motor 140, it becomes Z in FIG. 3. As described above, time for increasing the RPM by operating in advance the engine 120 that has been stopped is required to enter the HEV mode. According to an embodiment of the present invention, the RPM is controller by operating the engine 120 at a vehicle speed that is lower than the first vehicle speed by the reference value, so the engine 120 has time to prepare for synchronization with the driving motor 140 while the vehicle speed is increased as much as the reference value. This may be understood as the lock-up preparation control described above.

As a result, the driving modes of the vehicle according to the coolant temperature can be controlled more efficiently and more precisely by further setting the third mode between the second mode and the normal mode as described in an embodiment of the present invention. Accordingly, it is possible to reasonably satisfy the heating level required for the vehicle and improve the fuel efficiency when controlling the driving mode of the vehicle.

In particular, in the third mode, fuel consumption is minimized by not operating the engine 120 before it is required to enter the HEV mode, and the engine 120 is operated at a vehicle speed that is lower than the first vehicle speed by the reference value before the HEV mode is entered so that the engine 120 that has been stopped can be effectively synchronized with the driving motor 140.

Meanwhile, as shown in FIGS. 1 to 4, in the method of controlling a driving mode of a hybrid vehicle according to an embodiment of the present invention, in the second mode-performing step (S300), when the vehicle speed is the driving determination vehicle speed set in advance in the controller 200, the controller 200 determines that the vehicle is driven and the vehicle speed that is lower than the first vehicle speed by the reference value is higher than the driving determination vehicle speed.

In detail, when the third mode of the control modes of a vehicle is performed, the controller 200 operates the engine 120 at a vehicle speed that is higher than the vehicle speed that is lower than the first vehicle speed by the reference value.

That is, in the third mode, fuel consumption is reduced by decreasing the operation time of the engine 120, as compared with the second mode, and the reference value may be determined in various ways in terms of the control strategy in the third mode, as described above.

Further, in an embodiment of the present invention, in order to efficiently control the third mode to improve the fuel efficiency, the vehicle speed that is lower than the first vehicle speed by the reference value is set higher than the driving determination vehicle speed, whereby the fuel efficiency can be improved.

If the vehicle speed that is lower than the first vehicle speed by the reference value is the driving determination vehicle speed or less, the engine 120 may be further operated in the third mode than in the second mode. According to an embodiment of the present invention, the engine 120 may be operated at a vehicle speed higher than the driving determination vehicle speed to prevent this situation and reduce the operation time of the engine 120 in the third mode in comparison to the second mode.

Y is shown at a position that is lower by Z corresponding to the reference value than X1 corresponding to the first vehicle speed and is the RPM at the vehicle speed that is lower than the first vehicle speed by the reference value.

It can be seen that Y is lower than X1 but is larger than N, in which N is the RPM at the driving determination vehicle speed. That is, when the driving motor RPM is N, the engine 120 is operated in the second mode, and when the driving motor RPM is Y, the engine 120 is operated in the third mode, in which Y is set larger at least than N.

Accordingly, the operation time of the engine 120 can be reduced in the third mode in comparison to the second mode and the fuel efficiency in the third mode can be improved.

Meanwhile, as shown in FIGS. 1 to 4, the method of controlling a driving mode of a hybrid vehicle according to an embodiment of the present invention further includes a fourth mode-performing step (S500) in which when the coolant temperature is the third temperature or more and less than the critical temperature and the vehicle speed is equal to or higher than the second vehicle speed that is higher than the first vehicle speed and lower than the critical vehicle speed, the controller 200 drives the vehicle in the HEV mode.

In detail, the controller 200 performs the fourth mode when the coolant temperature is the third temperature or more and less than the critical temperature. As described above, the third temperature and the critical temperature may be various values.

In the fourth mode, the controller 200 controls the driving mode of the vehicle as the HEV mode at the second vehicle speed that is higher than the first vehicle speed and lower than the critical vehicle speed. The engine 120 is not operated in the fourth mode before it is required to change into the HEV mode as in the third mode or the normal mode.

Meanwhile, in the fourth mode, the HEV mode is entered at the second vehicle speed and the engine 120 at the second vehicle speed is operated at an operation point where the fuel efficiency is improved in comparison to that at the first vehicle speed.

As described above, when the operation point of the engine 120 is found on the basis of the engine torque and the engine RPM, the fuel efficiency of the engine 120 is changed in accordance with the engine RPM. Further, according to an embodiment of the present invention, the engine RPM corresponds to the operation point where the fuel efficiency of the engine 120 is improved in comparison to the engine RPM at the first vehicle speed and the engine RPM corresponding to the second vehicle speed in the fourth mode increases the fuel efficiency of the engine 120 more than at the first vehicle speed but decreases the fuel efficiency than at the critical vehicle speed. The RPM of the engine 120 or the driving motor at the second vehicle speed is X2 in FIG. 3.

That is, in the fourth mode, the engine 120 is operated at a vehicle speed that is lower than in the normal mode (at an earlier point of time from the stopped state), whereby the fuel efficiency of the engine 120 is decreased, as compared with the normal mode, but the heating level for the vehicle is improved.

Further, in the fourth mode, the engine 120 is operated at a higher vehicle speed than the third mode (at a later point of time from the stopped state), whereby the heating level for the vehicle is decreased, as compared with the third mode, but the engine 120 can be operated at an operation point with higher fuel efficiency, so the fuel efficiency is improved. The engine RPM controlled in the fourth mode is shown by a line D in FIG. 3.

Meanwhile, as shown in FIGS. 1 to 4, in the method of controlling a driving mode of a hybrid vehicle according to an embodiment of the present invention, when the vehicle speed is equal to or more than a vehicle speed that is lower the second vehicle speed by the reference value in the fourth mode-performing step (S500), the controller 200 operates the engine 120 to synchronize the engine RPM and the driving motor RPM at the second vehicle speed.

As described in relation to the third mode, when the vehicle speed is lower than the second vehicle speed by the reference value in the fourth mode, the controller 200 operates the engine 120. This corresponds to an RPM increase period in which the engine 120 can be synchronized with the current driving motor 140.

On the other hand, as shown in FIG. 4, a system for controlling a driving mode of a hybrid vehicle according to an embodiment of the present invention includes a temperature sensor 112 for measuring coolant temperature; an engine 120 for providing power for driving the vehicle or power for charging a battery 135 by rotating a generator 132; a driving motor 140 for providing power for driving the vehicle using electricity of the battery 135; and a controller 200 checking coolant temperature when a heating mode of the hybrid vehicle is turned on, increasing coolant temperature by always operating the engine 120 when the coolant temperature is less than a first temperature and driving the vehicle in an HEV mode when a vehicle speed is a first vehicle speed or more, operating the engine 120 only when the vehicle is driven and driving the vehicle in the HEV mode when the vehicle speed is the first vehicle speed or more, when the coolant temperature is the first temperature or more and less than a second temperature; operating the engine 120 so that engine RPM and driving motor RPM can be synchronized at the first vehicle speed and driving the vehicle in the HEV mode at the first vehicle speed when the coolant temperature is the second temperature or more and less than a third temperature and the vehicle speed is lower than the first vehicle speed by a reference value, driving the vehicle in the HEV mode when the coolant temperature is the third temperature or more and less than a critical temperature and the vehicle speed is equal to or higher than a second vehicle speed that is higher than the first vehicle speed and lower than a critical vehicle speed, and driving the vehicle in the HEV mode when the coolant temperature is the critical temperature or more and the vehicle speed is equal to or higher than the critical vehicle speed that is set higher than the first vehicle speed.

In detail, the temperature sensor 112 is provided to measure the coolant temperature. Preferably, a coolant is provided to cool the engine 120 and a coolant increased in temperature by heat from the engine 120 may be used for a heater module 116 in the vehicle.

The temperature sensor 112 measures the temperature of the coolant and is connected to the controller 200 to transmit/receive signals to be able to transmit measured temperature values to the controller 200. Further, a vehicle speed sensor 114 for measuring the vehicle speed may be provided in the present invention.

Meanwhile, the engine 120 provides power for driving the vehicle or power for charging the battery 135 by rotating the generator 132. In the present invention, the generator 132 may be provided separately from the driving motor 140 and the power from the engine 120 may be used to drive the vehicle or charge the battery 135 by rotating the generator 132.

Meanwhile, the driving motor 140 provides power for driving the vehicle using the electricity of the battery 135. The power from the driving motor 140 is used to drive the vehicle in an EV mode or the HEV mode. Further, preferably, a clutch member that can interlock the driving motor 140 and the engine 120 with their rotation synchronized may be provided and the state in which they are interlocked and rotated at the same RPM is defined as a lock-up state.

A first mode, a second mode, and a normal mode are set in advance as control modes for the vehicle in the controller 200 of the present invention. In the control modes for the vehicle set in the controller 200, an operation condition of the engine 120 and driving mode determination conditions of the vehicle are input and the controller 200 determines a control mode of the vehicle in accordance with the coolant temperature and determines whether to operate the engine 120 and a driving mode of the vehicle in accordance with the control mode.

In detail, the controller 200 checks the coolant temperature when the heating mode of the vehicle is turned on, and increases the coolant temperature by always operating the engine 120 and drives the vehicle in the HEV mode when the vehicle speed is the first vehicle speed or more, when the coolant temperature is less than the first temperature.

Further, the controller 200 operates the engine 120 only when the vehicle is driven and drives the vehicle in the HEV mode when the vehicle speed is the first vehicle speed or more, when the coolant temperature is the first temperature or more and less than the second temperature.

Further the controller 200 operates the engine 120 so that engine RPM and driving motor RPM can be synchronized at the first vehicle speed and drives the vehicle in the HEV mode at the first vehicle speed when the coolant temperature is the second temperature or more and less than the third temperature and the vehicle speed is lower than the first vehicle speed by a reference value.

Further, the controller 200 drives the vehicle in the HEV mode when the coolant temperature is the third temperature or more and less than the critical temperature and the vehicle speed is equal to or higher than the second vehicle speed that is higher than the first vehicle speed and lower than a critical vehicle speed.

Further, the controller 200 drives the vehicle in the HEV mode when the coolant temperature is the critical temperature or more and the vehicle speed is equal to or higher than the critical vehicle speed that is set higher than the first vehicle speed.

Although the present invention was described with reference to specific embodiments shown in the drawings, it is apparent to those skilled in the art that the present invention may be changed and modified in various ways without departing from the scope of the present invention, which is described in the following claims.

What is claimed is:

1. A method of controlling a driving mode of a hybrid vehicle, the method comprising:
a coolant temperature-checking step of checking, by a controller, a coolant temperature when a heating mode of the hybrid vehicle is turned on;
a first mode-performing step of increasing, by the controller, the coolant temperature by always operating an engine when the coolant temperature is less than a first temperature and of driving the vehicle in an HEV mode when a vehicle speed is a first vehicle speed or more;
a second mode-performing step of operating, by the controller, the engine only when the vehicle is driven and when the coolant temperature is the first temperature or more and less than the second temperature and of driving the vehicle in the HEV mode when the vehicle speed is the first vehicle speed or more; and
a normal mode-performing step of driving, by the controller, the vehicle in the HEV mode when the coolant temperature is equal to or higher than a critical temperature that is set higher than the second temperature and the vehicle speed is equal to or higher than a critical vehicle speed that is set higher than the first vehicle speed.

2. The method of claim 1, wherein in the second mode-performing step, when the vehicle speed is less than the first vehicle speed, the controller drives the vehicle in a series mode in which a battery is charged with power from the engine and the vehicle is driven by power from a driving motor.

3. The method of claim 1, wherein a driving determination vehicle speed for determining whether the vehicle is driven is set in advance in the controller, and
in the second mode-performing step, when the vehicle speed is the driving determination vehicle speed or more, the controller determines that the vehicle is driven and operates the engine.

4. The method of claim 1, further comprising:
a third mode-performing step in which when the coolant temperature is a third temperature that is the second temperature or more and less than the critical temperature and the vehicle speed is lower than the first vehicle speed by a reference value, the controller operates the engine so that engine RPM and driving motor RPM can be synchronized at the first vehicle speed, and drives the vehicle in the HEV mode at the first vehicle speed.

5. The method of claim 4, wherein in the second mode-performing step, the controller determines that the vehicle is driven when the vehicle speed is equal to or higher than the driving determination vehicle speed that is set in advance in the controller, and the vehicle speed lower than the first vehicle speed by the reference value is higher than the driving determination vehicle speed.

6. The method of claim 4, further comprising:
a fourth mode-performing step in which the controller drives the vehicle in the HEV mode when the coolant temperature is the third temperature or more and less than the critical temperature and the vehicle speed is a second vehicle speed that is higher than the first vehicle speed and lower than the critical vehicle speed.

7. The method of claim 6, wherein in the fourth mode-performing step, when the vehicle speed is lower than the second vehicle speed by the reference value, the controller operates the engine so that the engine RPM and the driving motor RPM can be synchronized.

8. A system for controlling a driving mode of a hybrid vehicle, the system comprising:
a temperature sensor for measuring coolant temperature;
an engine for providing power for driving the vehicle or power for charging a battery by rotating a generator;
a driving motor for providing power for driving the vehicle using electricity of the battery; and
a controller checking coolant temperature when a heating mode of the hybrid vehicle is turned on, increasing coolant temperature by always operating the engine when the coolant temperature is less than a first temperature and driving the vehicle in an HEV mode when a vehicle speed is a first vehicle speed or more; operating the engine only when the vehicle is driven and driving the vehicle in the HEV mode when the vehicle speed is the first vehicle speed or more, when the coolant temperature is the first temperature or more and less than a second temperature, operating the engine so that engine RPM and driving motor RPM can be synchronized at the first vehicle speed and driving the vehicle in the HEV mode at the first vehicle speed when the coolant temperature is the second temperature or more and less than a third temperature and the vehicle speed is lower than the first vehicle speed by a reference value, driving the vehicle in the HEV mode when the coolant temperature is the third temperature or more and less than a critical temperature and the vehicle speed is equal to or higher than a second vehicle speed that is higher than the first vehicle speed and lower than a critical vehicle speed, and driving the vehicle in the HEV mode when the coolant temperature is the critical temperature or more and the vehicle speed is equal to or higher than the critical vehicle speed that is set higher than the first vehicle speed.

9. A device for controlling a driving mode of a hybrid vehicle, the device comprising a controller performing:
a coolant temperature-checking step of checking, by a controller, a coolant temperature when a heating mode of the hybrid vehicle is turned on;
a first mode-performing step of increasing, by the controller, the coolant temperature by always operating an engine when the coolant temperature is less than a first temperature and of driving the vehicle in an HEV mode when a vehicle speed is a first vehicle speed or more;
a second mode-performing step of operating, by the controller, the engine only when the vehicle is driven and when the coolant temperature is the first temperature or more and less than the second temperature and of driving the vehicle in the HEV mode when the vehicle speed is the first vehicle speed or more; and
a normal mode-performing step of driving, by the controller, the vehicle in the HEV mode when the coolant temperature is equal to or higher than a critical temperature that is set higher than the second temperature and the vehicle speed is equal to or higher than a critical vehicle speed that is set higher than the first vehicle speed.

10. The device of claim 9, wherein in the second mode-performing step, when the vehicle speed is less than the first vehicle speed, the controller drives the vehicle in a series mode in which a battery is charged with power from the engine and the vehicle is driven by power from a driving motor.

11. The device of claim 9, wherein a driving determination vehicle speed for determining whether the vehicle is driven is set in advance in the controller, and
in the second mode-performing step, when the vehicle speed is the driving determination vehicle speed or more, the controller determines that the vehicle is driven and operates the engine.

12. The device of claim 9, further comprising:
a third mode-performing step in which when the coolant temperature is a third temperature that is the second temperature or more and less than the critical temperature and the vehicle speed is lower than the first vehicle speed by a reference value, the controller operates the engine so that engine RPM and driving motor RPM can be synchronized at the first vehicle speed, and drives the vehicle in the HEV mode at the first vehicle speed.

13. The device of claim 12, wherein in the second mode-performing step, the controller determines that the vehicle is driven when the vehicle speed is equal to or higher than the driving determination vehicle speed that is set in advance in the controller, and the vehicle speed lower than the first vehicle speed by the reference value is higher than the driving determination vehicle speed.

14. The device of claim 12, further comprising:
a fourth mode-performing step in which the controller drives the vehicle in the HEV mode when the coolant temperature is the third temperature or more and less than the critical temperature and the vehicle speed is a second vehicle speed that is higher than the first vehicle speed and lower than the critical vehicle speed.

15. The device of claim 14, wherein in the fourth mode-performing step, when the vehicle speed is lower than the second vehicle speed by the reference value, the controller operates the engine so that the engine RPM and the driving motor RPM can be synchronized.
